(19) United States
(12) Patent Application Publication
(10) Pub. No.: US 2009/0011713 A1
(43) Pub. Date: Jan. 8, 2009

(54) SYSTEMS AND METHODS FOR DISTANCE MEASUREMENT IN WIRELESS NETWORKS

(75) Inventors: Murad Abusubaih, Berlin (DE); Berthold Rathke, Berlin (DE)

Correspondence Address: COOLEY GODWARD KRONISH LLP;ATTN: Patent Group, Suite 1100, 777 - 6th Street, NW, WASHINGTON, DC, 20001, US

(73) Assignee: PROXIMETRY, INC., San Diego, CA (US)

(21) Appl. No.: 12/058,523

(22) Filed: Mar. 28, 2008

Related U.S. Application Data
(60) Provisional application No. 60/908,621, filed on Mar. 28, 2007.

(51) Int. Cl. H04B 17/00

(52) U.S. Cl. 455/67.11

(57) ABSTRACT

Systems and methods for distance measurement in wireless networks are disclosed. A method for measuring distance between nodes or devices in a wireless network comprises estimating a distance between network devices based on a first distance measurement method, estimating the distance based on a second distance measurement method, and processing the first and second distance estimates to determine convergence and to generate an enhanced distance measurement. Additional distance estimates may be combined to further improve accuracy. Convergence information may be provided indicating whether two or more distance estimates converge. In some implementations, the first distance estimate may be generated by a transmission time estimation method, the second distance estimate may be generated by a received signal strength distance estimate, the two estimates may be combined by averaging to generate an enhanced distance estimate, and the difference between the estimates may be compared to a threshold to determine whether the estimates have sufficiently converged to within a desired convergence range.

### CROSS REFERENCE TO RELATED APPLICATIONS

This application claim priority under 35 U.S.C. § 119(e) to U.S. Provisional Patent Application Ser. No. 60/908,621, entitled SYSTEMS AND METHODS FOR DISTANCE MEASUREMENT IN WIRELESS NETWORKS, filed on Mar. 28, 2007, the contents of which are incorporated by reference herein in their entirety for all purposes.

### FIELD OF THE INVENTION

The present invention relates generally to wireless networks. More particularly but not exclusively, the present invention relates to systems and methods for measurement of distances between nodes or devices in wireless networks, such as IEEE 802.11 wireless networks, using two or more distance estimates to improve distance measurement performance over single estimate methods.

### BACKGROUND OF THE INVENTION

Wireless networks, such as wireless local area networks (WLANs) based on the IEEE 802.11 standard, as well as those based on other standards such as IEEE 802.16, commonly use information related to distances between network devices and nodes, such as the distance between a client computer and an access point. Several distance estimation methods have been used to generate approximate measurements of distance between network nodes. For example, received signal strength indicator (RSSI) and signal propagation time (SPT) based estimates have been widely used for distance estimation in indoor WLAN deployments, however, neither approach by itself is typically very accurate. Moreover, there is currently no reliable means by which WLAN nodes can know whether the estimated distance is accurate or not. Therefore, a need exists for improved distance measurement and accuracy assessment in wireless networks.

### SUMMARY

In one aspect, the present invention relates to a method for enhanced distance measurement in a wireless network. Distance estimates between nodes in a wireless network, such as distances between client devices and access points, may first be determined by two or more distance estimation methods. The two or more distance estimates may then be processed to cross check against each other for convergence as well as generation of an enhanced distance estimate. Information on convergence or non-convergence of the estimates within a preset error threshold and/or within a predefined measurement time duration may also be provided.

In another aspect, the invention relates to a system comprising a wireless network including enhanced distance measurement capability wherein an enhanced distance estimate between network nodes based on a plurality of distance estimates is provided.

In another aspect, the invention relates to a computer readable medium including instructions for generating an enhanced distance estimate based on a plurality of distance estimates.

Additional aspects of the present invention are further described below in the detailed description section in conjunction with the drawings.

### BRIEF DESCRIPTION OF THE DRAWINGS

For a better understanding of the nature and objects of various embodiments of the invention, reference should be made to the following detailed description taken in conjunction with the accompanying drawings, wherein:

FIG. 1 is a simplified illustration of a wireless network on which may be implemented embodiments of the present invention.

FIG. 2 is a simplified block diagram of an embodiment of a processing workflow according to aspects of the present invention.

FIG. 3A is a simplified block diagram of an embodiment of a processing workflow in accordance with aspects of the present invention.

FIG. 3B is a simplified block diagram of an embodiment of a processing workflow in accordance with aspects of the present invention.

FIG. 4 is a graph illustrating distance estimate convergence in accordance with one embodiment of the present invention.

### DETAILED DESCRIPTION OF EMBODIMENTS OF THE INVENTION

The present invention is related generally to systems and method for distance measurement in wireless networks such as those based on the IEEE 802.11 family of wireless networking standards.

In one aspect, the present invention relates to a method for enhanced distance measurement in a wireless network. Distance estimates between nodes in a wireless network, such as distances between client devices and access points, may first be determined by two or more distance estimation methods. The two or more distance estimates may then be processed to cross check against each other for convergence as well as generation of an enhanced distance estimate. Information on convergence or non-convergence of the estimates within a preset error threshold and/or within a predefined measurement time duration may also be provided.

In another aspect, the invention relates to a system comprising a wireless network including enhanced distance measurement capability wherein an enhanced distance estimate between network nodes based on a plurality of distance estimates is provided.

In another aspect, the invention relates to a computer readable medium including instructions for generating an enhanced distance estimate based on a plurality of distance estimates.

Additional aspects of the present invention are further described below in conjunction with the drawings.

In addition, aspects of the present invention are also described in a related publication by the inventors, M. Abusubaih, B. Rathke, and A. Wolisz, “A Dual Distance Measurement Scheme for Indoor IEEE 802.11 Wireless Local Area Networks,” International Conference on Mobile and Wireless Communication Networks (MWCN '07), Cork, Ireland, September 2007, the contents of which are incorporated by reference herein.

While embodiments disclosed below are typically described in terms of wireless local area networks (WLANs) such as those based on the popular IEEE 802.11 wireless local area network standard, the systems and methods described herein are not so limited, and embodiments based on other WLAN configurations, as well as other wireless networks such as WI-MAX networks, are possible and envisioned. Accordingly, the embodiments disclosed herein are provided for purposes of illustration, not limitation.

Recently WLANs have become very popular and widely deployed. Due to decreasing costs of equipment (e.g., wireless access points, also denoted herein as APs, wireless network cards, and other network components) and fixed broadband connections (digital subscriber lines or DSLs), WLANs have become the preferred technology of access in homes, offices, and hot-spot areas such as hotels, food service establishment, airports and meeting rooms. Although several standards for WLAN originally competed, today virtually all WLANs are based on the IEEE 802.11 standard. Therefore, embodiments as further described below are provided in the context of the IEEE 802.11 standard.

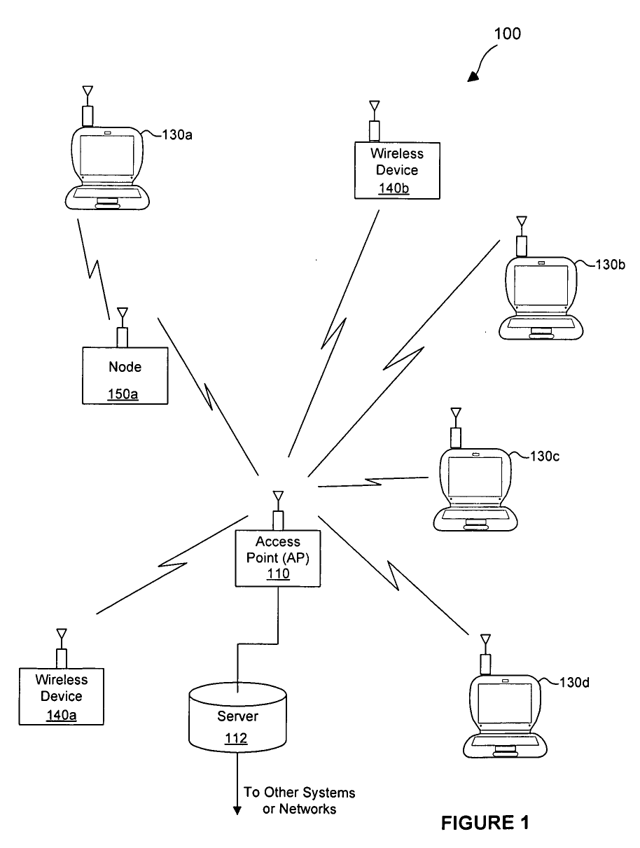

FIG. 1 provides a simplified illustration of a wireless network 100, such as a WLAN based on the IEEE 802.11 standard, on which embodiments of the present invention may be implemented. It will be noted that the types and numbers of components and component interconnections in a wireless network vary widely, and therefore the illustration in FIG. 1 is provided merely to show a general wireless network configuration. WLAN 100 may include one or more access points 110, wherein the access points may be connected via wired or wireless connections to other network devices including devices such as server 112 and/or other computer systems. Server 112 may further be connected via wired or wireless connections to other networks or communications backbones (not shown) such as a local area network, wide area network, the Internet, telecommunications systems, or other networks. Server 112 may include hardware, software, data, or other information that may be distributed throughout the coverage area of WLAN 100.

WLAN 100 may also include one or more wireless devices such as handheld wireless devices, personal computers, personal digital assistants (PDAs), or other types of devices configured for connection to such a wireless network. As shown in FIG. 1, WLAN 100 may contain one or more computers 130a-n, such as desktop, notebook or laptop computers, configured to communicate over the wireless network, as well as other wireless devices 140a-n such as stationary or handheld wireless devices, nodes 150a-n such as repeaters, as well as other wireless devices (not shown). It is noted that any particular wireless device or devices may be either stationary or mobile depending on the network configuration. In addition, devices may be added to the network and/or removed from the network based on user and/or device operational needs.

In many wireless networks it may be desirable to be able to determine distances between two or more wireless nodes/devices, such as those shown in WLAN 100 of FIG. 1. For example, in WLAN 100 it may be desirable to determine the distance between access point 110 and node 150a, between access point 110 and wireless devices 140a or 140b or computers 130a-d. Other distance determinations between devices in the network may also be desirable, such as, for example, determining the distance between computer 130a and node 150a and device 130a and access point 110 in order to determine the appropriate connection point in the network for computer 130a. In accordance with aspects of the present invention, embodiments of such distance determination systems and methods may comprise software, hardware, firmware, or a combination of one or more of these elements in various forms including hardware and/or software devices and modules.

Measurement of WLAN Node Distances

The knowledge of WLAN users'/device locations is becoming increasingly important for both location based applications and network performance improvement. Therefore, determining the location of a wireless network client in a network such as WLAN 100 has attracted considerable attention from many researchers and manufacturers. From the network point of view, the ability to measure the distance between mobile users (also denoted herein as clients or client terminals based on the underlying client wireless devices) and access points (APs) would help in addressing many issues including handover decisions, AP selection, locating rogue APs, locating sources of interference, locating specific users, balancing the load among WLAN APs, as well as for addressing other issues. At least two common approaches have been extensively to date to measure distances in wireless networks. These include approaches based on received signal strength indication (RSSI approach) and signal propagation time (SPT approach), which are further described below.

The RADAR system, described in Paramvir Bahl and Venkata N. Padmanabhan, “An In-Building RF-Based User Location and Tracking System,” INFOCOM 2000, pgs. 775-84, Te-Aviv, Israel, March, 2000, is probably the first positioning system using IEEE 802.11 for indoor WLAN deployments. This approach is based on RSSI maps constructed in an offline phase. Other studies that make use of RSSI to infer locations can be found in Kremenek T., Muntz R., Castro P, and Chiu P., “A probabilistic location service for wireless network environments,” Proceedings of Ubicomp, pgs. 18-24, September, 2001; Kogan D., Smailagic A., “Location sensing and privacy in a context-aware computing environment,” IEEE Wireless Communications, 9(5), pgs. 10-17; Moustafa Yousief, “Horus: A WLAN-Based Indoor Location Determination System,” PhD Dissertation, Department of Computer Science, University of Maryland, 2004; Kogan D. and Kaemarungsi K., “Distribution of WLAN Received Signal Strength Indication for Indoor Location Determination,” Proceedings of the 1st International Symposium on Wireless Pervasive Computing, January 2006. Each of these references is incorporated by reference herein.

Alternately, in some wireless systems, a propagation time based approach based on signal transmission times and corresponding distance measurements may be used. For example, a propagation time based approach is used in both outdoors and indoors positioning systems such as the global positioning system (GPS), as described in Misra P. & Enge P., Special Issue on GPS: The Global Positioning System, IEEE, 1999, incorporated by reference herein.

Some authors, such as Gunther A. & Hoene C., “Measuring Round Trip Times to Determine The Distance between WLAN Nodes,” Proceedings of Networking, Waterloo, Canada, May, 2005, incorporated by reference herein, have proposed an improved propagation time based distance measurement approach for IEEE 802.11 WLANs. The authors use a packet latency based approach for outdoor distance measurements. This approach utilizes a features of IEEE 802.11 networks known as the immediate acknowledgment feature. The immediate acknowledgment feature can be used to measure the time difference between sending a data packet and receiving the corresponding acknowledgment by measuring propagation time to another wireless device. More recently, another round trip time based approach that uses RTS/CTS frames has been proposed in Barcelo F., Paradells J., Zola E., Izquierdo F., Ciurana M., “Performance evaluation of a TOA based trilateration method to locate terminals in WLAN,” Proceedings of the 1st International Symposium on Wireless Pervasive Computing, January, 2006, incorporated by reference herein. However, the results of this work are based on simulations rather than real experiments.

Unfortunately, due perhaps to the multipath fading effect and obstructions, the accuracy of the previously cited approaches is typically low, on the order of 2-5 meters, when utilized alone. This calls for a new enhanced approach that may improve the estimations' accuracy.

In addition to the previously described RSSI and SPT approaches, other methods for distance measurement may be used. These include phase slope versus frequency line approaches, such as are described in U.S. Pat. No. 6,731,908, entitled DISTANCE MEASUREMENT USING HALF DUPLEX TECHNIQUES, incorporated by reference herein, silent echo generation approaches, such as are described in U.S. Pat. No. 5,945,949, entitled MOBILE STATION POSITION DETERMINATION IN A WIRELESS COMMUNICATION SYSTEM, incorporated by reference herein, as well as other techniques for distance measurement known or developed in the art.

In some embodiments of the present invention, enhanced methods and systems may be implemented by combining the results of two distance measurement estimates to determine a more accurate and reliable distance estimate. In addition, in some embodiments, accuracy may be further improved by using multiple estimates, particularly when the estimates are fully or partially statistically independent of one another. In some embodiments, the two or more estimates may be performed simultaneously, thereby increasing overall distance measurement efficiency as well as accuracy.

In one embodiment, a combined approach may use both signal strength and propagation delay approaches. In an exemplary embodiment, RSSI and Packet Propagation Delay (PPD) parameters are used to cross-validate the accuracy and increase the degree of confidence of the estimated distance. Hence, this approach can reduce false decisions that might be based on inaccurate results. Moreover, such a hybrid approach may also reduce the time period required to obtain estimations specified for any particular single approach, such as by performing the two estimates substantially simultaneously. Consequently, bandwidth may be preserved by reducing wireless bandwidth required for signaling overhead during measurements.

Packet Propagation Delay (PPD)—Based Distance Measurements

In one embodiment, a signal propagation time based approach based on packet propagation delay (PPD) may be used for one of the distance measurement estimates. In order to better understand this approach, the basic concepts are briefly described below.

In embodiments based on 802.11 WLANs, the PPD approach may utilize an important feature of IEEE 802.11 known as the immediate acknowledgment feature. In other types of wireless networks, similar features or functionality provided for measuring propagation time may alternately be used. In an IEEE 802.11 system, every unicast data packet is immediately acknowledged. Embodiments using the PPD approach may take advantage of drifting clocks to determine propagation times that may be many times smaller than the clocks' resolution. For example, in some embodiments the propagation times may be approximately forty times smaller than the clocks' quantization resolution.

In brief, a typical PPD implementation works as follows. First, the time span from the moment at which a packet starts to occupy the wireless medium to the time at which the immediate acknowledgment is received is measured. The measured time is denoted as T_{Remote}. The time duration between the reception of a data packet and issuing the corresponding immediate acknowledgment, denoted as T_{Local}, is also measured. Then, the distance d_{PPD} may be computed as shown in equation (1) based on the relation between the distance traveled and the speed of electromagnetic propagation (for example, the speed of light c may be used, or other estimates of radio propagation through particular mediums such as air may also be used) as follows:

$${d}_{PPD} = \frac{( {T}_{Remote} - {T}_{Local} )}{2} \times c \qquad ( 1 )$$

where c≈3×10⁸ meters/second is the speed of light.

As operating system interrupts and other processing may add some extra delay, the WLAN card MAC time stamps may be used rather than the operating system time stamps. The resolution of WLAN cards is typically 1 μs during which a signal would reach 300 m. Therefore in order to be able to increase the resolution, time estimation using the PPD approach may be based on determining results over a large number of packets, which makes the approach difficult to be utilized alone in real world applications.

RSSI Based Distance Measurement Approach

In some embodiments a received signal strength indicator (RSSI) based measurement approach may be used for one of the distance measurement estimates. In an RSSI based implementation, the power of the received signal at a WLAN node can be related to the transmitted power, as shown in equation (2), as:

P_{Rx}=P_{Tx}−P_{L}+P₁ (2)

where P_{T}_{_{X}} is the power of the transmitted signal, typically given in dBm. P₁≈4.2 (dB) denotes an environment power correction factor, as described in Larry G., Ivan S., Praveen G., and Predrag S., “A Method for Predicting the Throughput Characteristics of Rate Adaptive Wireless LANs,” Proceedings of the IEEE Vehicular Technology Conference VTC'04, Los Angeles, Calif., pp. 4528-32, September, 2004, incorporated by reference herein. P_{L} is the path loss in dB given in equation (3) as:

$${P}_{L} = {P}_{L} ( {d}_{0} ) + 10 n {log}_{10} ( \frac{d}{{d}_{0}} ) + {P}_{s} \qquad ( 3 )$$

where d₀ is the reference distance usually chosen to be 1 m, P_{L}(d₀)≈50.4 (dB) is the reference path loss, n=3.1 is the path loss exponent, and PS is the loss in power due to shadowing. Typically used values for Pₛ can be found in Chris R., Joel B., Binghao L., Andrew D., “Hybrid method for localization using WLAN,” Spatial Sciences Conference, Melbourne, Australia, pp. 341-350, September, 2005, incorporated by reference herein.

The relationship between the received signal power at a WLAN node and the RSSI value recorded by and reported by adapters is vendor dependent. For example, with Atheros chipsets, the received power P_{Rx} is simply computed by subtracting 95 from the reported RSSI value. Hence,

P_{Rx}=RSSI−95 (4)

After substituting the constant parameter values and rearranging, the distance can be estimated as:

$${d}_{RSSI} = 10 \frac{( {P}_{Tx} + 48.8 - RSSI - {P}_{s} )}{31} \qquad ( 5 )$$

Combined Distance Measurement Approach

Rather than using a single measurement estimate such as those described above, it may be advantageous to estimate distance based on two or more distance estimates, particularly where the multiple estimates have some degree of statistical independence. In some embodiments of the present invention as described in further detail below, a combined distance measurement approach, also referred to herein as the multiple estimate approach, may be used. It is noted that the terms dual approach and multiple estimate approach may be interchanged herein in describing some embodiments. It is further noted that the term dual approach refers to a version of the multiple estimate approach wherein two distance measurement estimates are used, while the term multiple estimate approach includes two estimates as used in the dual approach as well as other implementations where more than two estimates are used.

One aspect of embodiments of a multiple estimate approach in accordance with the present invention relates to statistical independence of the chosen distance estimate processes. In a multiple estimate approach it will typically be desirable that two or more of the chosen distance estimation processes generate results that are statistically independent or at least substantially statistically independent. For example, as described previously, the measured distance d_{PPD} may be a linear function of the round-trip time whereas d_{RSSI} may be an exponential function of received power level. In a typical dual estimate embodiment, each estimation method is selected to use different parameters with different functions to estimate the distance between two WLAN nodes. Under these assumptions, both measurement methods are statistically independent from each other, and therefore each method may be used to validate the other one. Even if there is some statistical dependency between the two methods (due to, for example, fading effects of the wireless channel) and both methods fail to estimate the distance, it will be expected that both methods will not converge to the same value, because they use different approaches to estimate the distance. In typical implementations, it is very likely that the true distance may fall between the two estimates, and therefore using an average value of the two estimates may still provide useful information. The ultimate value of the estimate would depend on specific use cases and a disparity of estimates

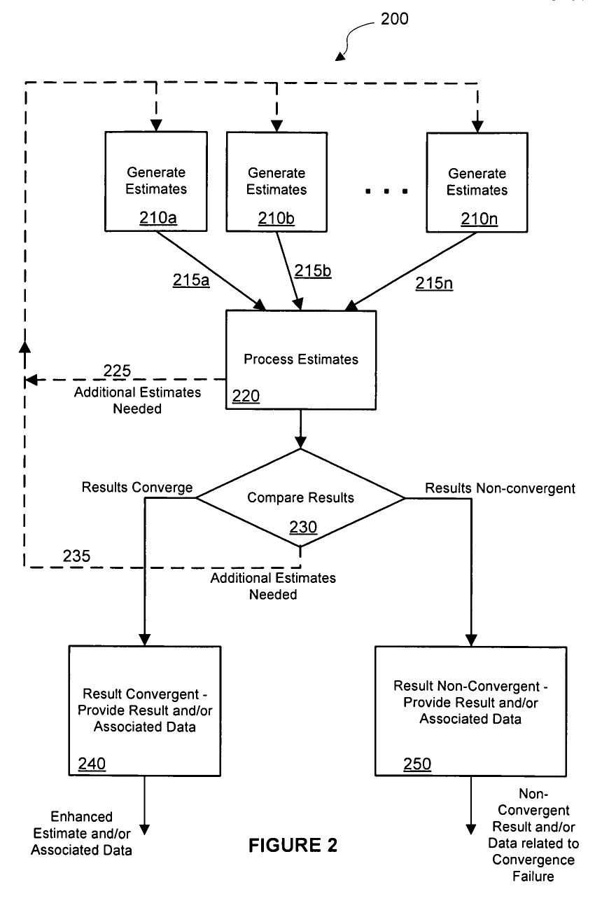

A general illustration of the processing workflow of one embodiment of a multiple estimate approach that may be used in a wireless network such as WLAN 100 is provided in FIG. 2. As shown in FIG. 2, two or more distance estimates 215a-n may be generated respectively by two or more distance measurement processes at stages 210a-n based on two or more distance estimation methods. In one embodiment, a first distance estimate 215a may be based on a PPD approach process and a second estimate 215b may be based on an RSSI approach process. The provided distance estimates 215a-n may be based on a single distance estimation using the associated distance estimation method and/or may be based on multiple distance estimates generated by the respective distance estimation process and further processed, such as by averaging the multiple estimates to generate the provided estimate and/or generating a time weighted estimate based on the multiple estimates.

In addition to the described RSSI and PPD approaches, other distance estimation methods may alternately be used. For example, in some embodiments the other distance estimates could be based on other distance estimate approaches such as the phase slope vs frequency line approach or silent echo generation approach described previously, or using other approaches known or developed in the art.

The estimates 215a-n may then be further processed at intermediate stage 220 to determine whether a sufficient time period has elapsed for a desired measurement accuracy and/or to determine whether the estimates and/or estimate differences are approximately constant, diverging or converging, and/or have remained within a convergence criteria for a specific period of time. Alternately, in some embodiments stage 220 may be bypassed and the results of the multiple estimates generated at stages 210a-n may be provided directly to a comparison stage 230 for direct evaluation as to convergence or non-convergence.

Depending on the results of the processing and associated convergence determination at stage 220, processing may return on path 225 to stages 210a-n to generate one or more additional distance estimates 215a-n which may again be processed at stage 220. For example, in some embodiments processing could be repeating for a fixed time to achieve the greatest possible accuracy within that time period. Alternately, in some embodiments, convergence of two or more estimates may be determined at stage 220 by comparing the estimates with a predefined error margin and exiting stage 220 once that error margin is reached. For example, in some embodiments, a desired measurement accuracy of 90 percent may be selected, resulting in a corresponding error margin of 10 percent. If two or more estimates converge to within this error margin, processing may be stopped at stage 220 to save additional processing time, with execution then proceeding to stage 230. In some embodiments, convergence may be based on a fixed distance metric rather than on a percentage. For example, convergence may be assessed based on two or more of the estimates converging to values within a fixed distance difference of, for example, 1 meter. In some embodiments convergence may be assessed based on whether two or more distance estimates are converging over time. For example, if the differences between two or more estimates is decreasing over time, the estimates may be repeated until two or more of the estimates are within a predefined percentage or distance difference of each other.

Alternately, if the multiple estimates fail to converge to a desired range, processing may be returned to stages 210a-210n for additional estimates via path 225. In addition, the maximum processing duration of stage 220 may be fixed in time so that if processing time exceeds a predefined measurement duration, irrespective of whether convergence occurs, execution may continue to stage 230.

If the received distance estimates at stage 220 are sufficiently stable (such, as, for example, having maintained a stabilized value over a plurality of measurements, having converged to a stable value over a plurality of estimates within a predefined time period, having reached a predefined error margin, etc.) and no additional estimates are desired, processing may proceed from stage 220 to a compare results stage 230 where the results of the estimates may then be compared and convergence or non-convergence results may be generated and/or stored. Convergence or non-convergence results typically include an enhanced distance estimate D and/or associated data, such as the individual estimates, information on conversion, as well as other related data.

The estimates provided to stage 230 may be compared to determine their absolute convergence accuracy and/or may be compared to determine whether two or more of the results have converged and/or stabilized within a predetermined range of accuracy, such as within 5, 10, 20 percent or other percentages of each other, and/or within a predetermined distance metric, such as 1, 5, or 10 meters, or based on other comparison metrics. In some embodiments, the convergence criteria may be selected based on a predefined measurement precision or accuracy. For example, in some applications there may be a need to estimate distance within a certain percentage, such as 90 percent, which would mean a distance estimation difference error margin less than or equal to 10 percent. In this case, when two or more estimates converge within this error margin the results may be considered to be converging, whereas if none of the estimates converge within the desired range, the results may be considered to be non-converging (or diverging). An enhanced distance estimate may then be generated and stored based on 2 or more of the N distance estimates.

A variety of convergence comparison algorithms may be used to assess convergence at stage 220 and/or stage 230, such as comparing the results of all of the 1 to N measurement estimates to determine whether they are within the desired convergence error margin, or comparing the results for a subset, M, of the 1 to N estimates for convergence, where M could be 2, 3, or more of the N estimates. Other comparison methods as are known or developed in the art could alternatively be used.

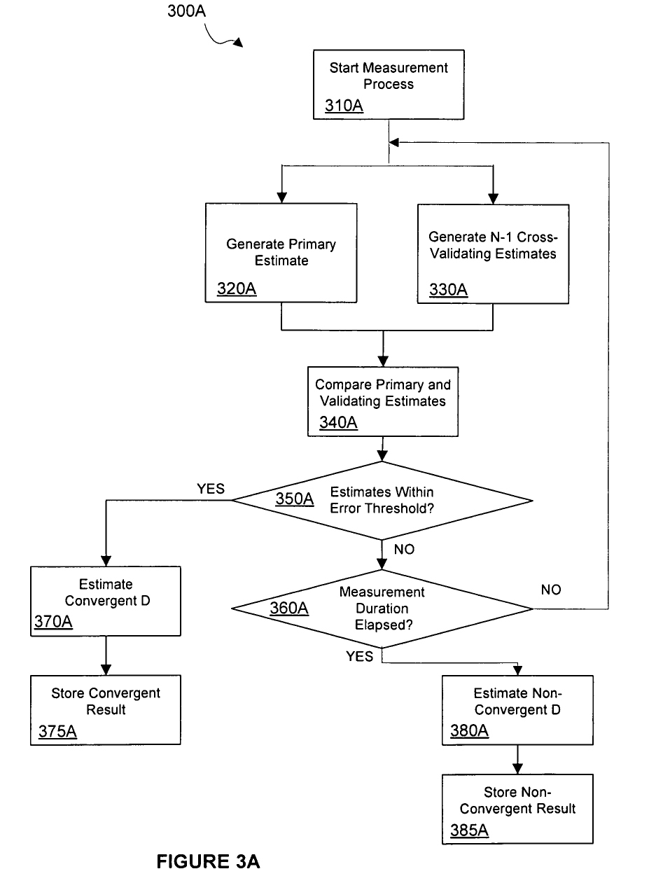

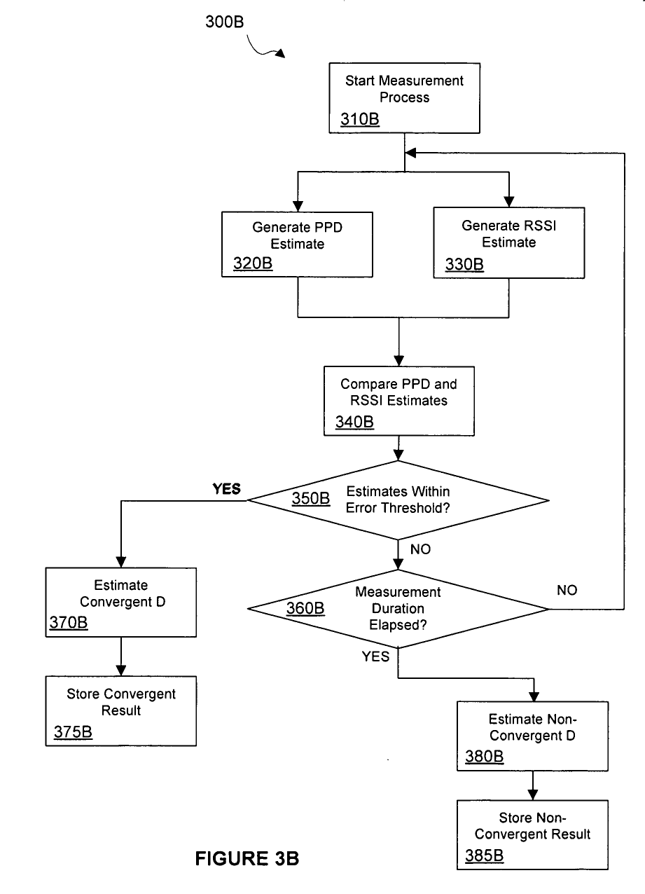

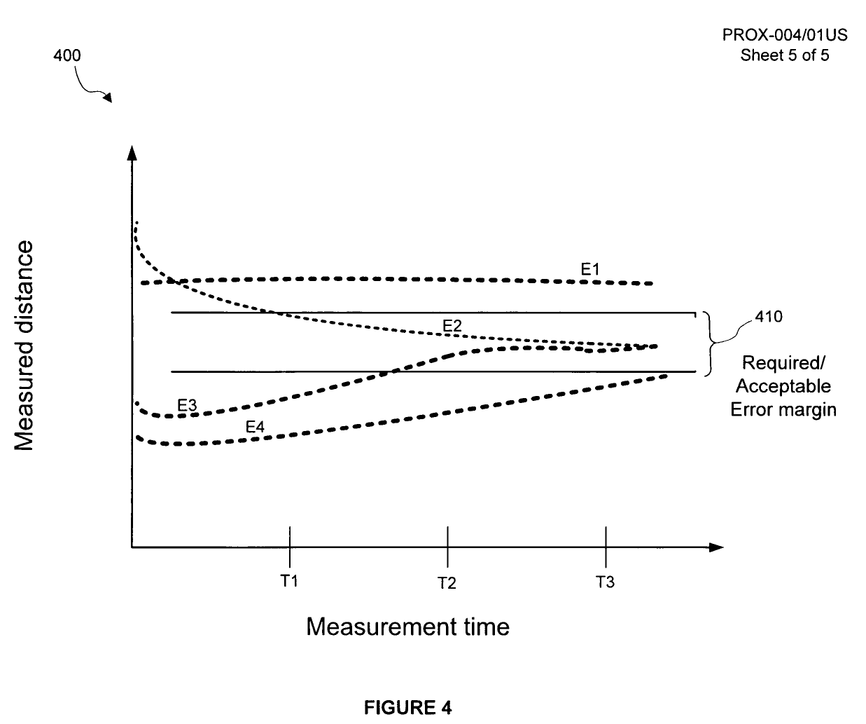

FIG. 4 illustrates additional aspects of convergence determination in accordance with one embodiment of the present invention. Graph 400 illustrates convergence behavior of four estimates (E1-E4) of distance based on four estimation methods. Convergence of the estimates may be tested at times T1, T2 and T3. An error margin (error threshold) 400 defines the acceptable error bounds for convergence. In accordance with a process such as process 200 (as well as, in some embodiments, processes 300A and 300B as shown in FIGS. 3A and 3B, as well as other similar or equivalent processes), a first set of distance estimates is determined and stored at time T1, which may correspond with stage 220 of process 200, with the initial distance estimates falling outside of the convergence bound. Since the estimates shown in FIG. 4 at time T1 are all outside of the error bounds, the estimates may then be repeated at stages 210a-210n via path 225, with the new estimate results then provided to stage 220 and/or combined with previous estimates and provided to stage 220. The new estimates may then be compared at time T2 for convergence with respect to the estimates determined at time T1. In this case, estimates E2 and E3, as well as E4 are converging, with estimate E1 diverging from the others. In some embodiments, process stage 220 may be terminated at this point because some of the estimates (i.e., E2 and E3) have converged to within the error bounds, and execution may then be transferred to stage 230. Alternately, in some embodiments the estimates may again be repeated at time T3 for further convergence assessment, where, in this example, estimate E4 is now also within the error bounds. The process may further continue until the estimates no longer appear to be converging and/or until M of the N estimates have converged to within the error margin. In some embodiments, estimates that are not converging (or are diverging), such as estimate E1, may be disregarded and/or discarded when calculating the composite distance estimate.

If the results indicate convergence at stage 230, processing may continue at stage 240 by providing and/or storing a convergence result. The convergence result may include the enhanced estimate, such as an average or weighted average of 2 or more of the N estimates, and/or any additional information related to result convergence, such as the individual estimates provided by the 1 to N estimates generated at stages 210a-n, whether the results converge within a selected error threshold, and/or any other related convergence data. Alternately, if the results fail to converge, such as, for example, if the results are outside a predefined error threshold, or are otherwise non-converging (or diverging), processing may continue at stage 250 with storage and/or providing of a non-convergence result. The non-convergence result may include an indication of non-convergence (or divergence), a non-converging distance estimate, such as an average of 2 or more of the N results, and/or may include the respective non-converging estimates and/or any related data, such as how far the estimates diverge or other related information. In some embodiments, the entire estimation process may be repeated following stage 230 via optional path 235, such as when there is non-convergence at stage 230.

In either the case of convergence or non-convergence, the enhanced estimate, convergence or non-convergence data, and/or any other related data or information may be stored in a memory of the associated wireless networking device or devices for further access, and/or may be transmitted via a wired or wireless connection to other networked wireless devices and/or other system resources, such as the wireless devices 110, 130a-d, 140a-b, 150a, and server 112 as shown in FIG. 1, as well as to other networked wired or wireless devices.

Another embodiment of the present invention is described below with respect to FIG. 3A. As with the previously described embodiments, multiple distance measurement estimates may be used in a wireless network such as WLAN 100, wherein the estimates are preferably independent from each other. Each estimate may be calculated by a different distance estimation method and associated algorithm, such as those described previously herein, with each method typically producing an independent distance estimate used to compare to and/or validate the estimate of the others, and the estimates may be done in parallel to improve processing efficiency and/or to reduce estimation time. Moreover, if no validation is possible it may be assumed that one or more of the underlying distance estimates is erroneous, and corresponding results and associated data may be stored for further use in the wireless network. In addition, even if validation is not possible, a non-converging enhanced distance estimate D may still be generated, such as by using an average or weighted average of two or more of the non-converging distance estimates. Since the actual distance may lie somewhere between the individual distance estimates, the non-converging estimate may still have some value as a distance estimation, even if the results are non-converging.

Table 1 below summarizes some notation used below with respect to the process 300A of FIG. 3A.

TABLE 1
Distance Measurement Notations

| Symbol | Meaning |
|---|---|
| dₙ | Estimated Distance of process/algorithm n |
| Tₚ | default specified measurement time of primary |
| | algorithm N |
| D | Multi-Estimate distance estimate |
| e | Convergence error threshold |

In the embodiment of process 300A shown in FIG. 3A, a primary estimate is generated, with N−1 additional cross-validating estimates also generated and compared to the primary estimate for convergence. Parameter dₚ is the estimated distance provided by the primary distance estimation algorithm. Parameter dₙ is the estimated distance provided by distance estimate algorithm n. Parameter Tₚ is a predefined measurement duration, such as a specified measurement duration for the primary algorithm to achieve convergence. Since it may be desirable to perform multiple iterations of the primary algorithm to assess convergence, Tₚ will typically be longer than the duration of a single distance estimate dₚ generated by the primary algorithm. Alternately, in some embodiments Tₚ may be set to a different duration based on other parameters, such as a maximum overall distance measurement duration, or other criteria.

Assuming that N−1 validating processes and associated algorithms are used to cross-validate the primary processing algorithm, let e be a convergence error threshold that denotes the maximum acceptable difference between the estimates of the N−1 validating processes and the primary process.

In one embodiment, the multi estimate approach may be implemented in accordance with process 300A as further described below (note that the stages and their described order are provided for purposes of description only and that other stages and/or orders are possible and envisioned).

Process 300A may begin at a start stage 310A. The primary estimate dₚ may then be generated at stage 320A, and the N−1 cross-validating estimates dₙ may be generated at stage 330A. In typical embodiments the cross-validating estimates may be generated simultaneously with the primary estimate to improve overall efficiency. A comparison may be performed at stage 340A, where the comparison will generally compare an error function of the N−1 estimates with the primary estimate for a specified time period T_{w} as shown in (6):

(Error [dₚ−dₙ] for all n=1 to N−1)≦e for a continuous time period of T_{w} seconds (6)

If the error function is less than the error threshold e, where the error threshold may be based on a percentage difference between the estimates, a fixed error threshold (such as a fixed distance), or other error criteria, then the results may be considered to have converged at stage 350A, and a convergent enhanced distance estimate D may be generated at stage 370A. In one embodiment D may be based on a mean value or other weighted value of the N estimates. In some embodiments D may be based on a subset, M, of the total number of estimates N. In any case, the estimate D and any additional data, such as the N distance estimates, data related to convergence and convergence thresholds, and/or other associated data may be stored as a convergence result at stage 375A and/or made available to other wired or wireless device on the network or on other connected networks.

Alternately, if the error is not within the error threshold e for the specified time period T_{w} at stage 360A, and if the total measurement elapsed time has not exceeded Tₚ, execution may return to stages 320A and 330A for additional primary and/or validating estimate generation.

If time period Tₚ has elapsed, estimation may be stopped at stage 360A, with a non-converging result, including a non-converging enhanced estimate D, optionally generated at stage 380A and/or the non-converging results and/or any associated data stored at stage 385A and/or distributed to other wired or wireless devices connected to the network.

In some embodiments, process stages 380A and 385A may be omitted, with execution returning to stage 310A to repeat the measurement process one or more additional cycles.

In some embodiments of process 300A the following observations may be relevant. First, if convergence frequently occurs before Tₚ elapses, the overall measurement duration could be decreased either statically or dynamically. This time reduction may depend on how often the N−1 validating algorithms converge and/or how early they converge. Second, repeating the measurement process upon failure of convergence at stage 360A may offer more confidence as to the correctness of the measured value, although it may not be a sufficient condition for its correctness. Therefore, in some embodiments it may be advantageous to repeat the process stages of process 300A multiple times in order to generate a more reliable estimate. Third, in spite of the fact that restarting a measurement may insert additional time, the possibility of convergence has the potential for saving some time in other measurements performed in the wireless system.

Another embodiment of the present invention implementing a dual approach based on the embodiment of FIG. 3A is illustrated in process 300B shown in FIG. 3B. In this embodiment, the primary (first) estimate may be based on a PPD approach and the validating (second) estimate may be based on an RSSI approach. Although other implementations substituting other estimates for the primary and validating estimates may alternately be used, this implementation may provide advantages due to the fact that the RSSI estimate is typically available in an 802.11 WLAN in addition to the PPD estimate and therefore imposes little to no additional processing or time costs.

In accordance with this embodiment, the measurement time of the RSSI and PPD approaches may be denoted by T_{RSSI} and T_{PPD} respectively, with E being the convergence error threshold e. Parameter d_{PPD} is the estimated distance provided by the primary distance estimate. Parameter d_{RSSI} is the estimated distance provided by the RSSI distance estimate. Parameter T_{PPD} is a predefined measurement duration, such as the convergent measurement time of the primary (PPD) measurement method. Since it may be desirable to perform multiple iterations of the primary algorithm to assess convergence, T_{PPD} will typically be longer than the duration of a single distance estimate d_{PPD} generated by the primary algorithm. In some embodiments T_{PPD} may be set to a different duration based on other parameters, such as a predefined maximum overall distance measurement duration, or may be set based on other criteria.

The measurement process may begin at a start stage 310B. The primary PPD estimate d_{PPD} may then be generated at stage 320B, and the validating RSSI estimates d_{RSSI} may be generated at stage 330B. In typical embodiments the RSSI estimate may be generated simultaneously with the PPD estimate to improve overall measurement processing efficiency. A comparison may be performed at stage 340B, where the comparison will generally compare an error function of the PPD estimate with the primary estimate for a specified time period T_{w}. In one embodiment of the error function as shown in equation (7), the error function is based on the average of the absolute value of the difference between the PPD and RSSI estimates, which is compared to the convergence error threshold ε.

Average (|d_{PPD}−d_{RSSI}|)≦ε for a continuous time period of T_{w} seconds (7)

If the error function is less than the error threshold ε, then the results may be considered to have converged at stage 350B, and the convergent enhanced distance estimate D may be generated at stage 370B. In one embodiment D may be based on a mean value or other weighted value of the PPD and RSSI estimates. The convergence result, including the estimate D and any additional data, such as the PPD and RSSI estimates, data related to convergence and convergence thresholds, and/or other associated data may be stored at stage 375B and/or made available to other wired or wireless devices on the wireless network or on other networks.

Alternately, if the error is not within the error threshold ε for the specified time period T_{w} at stage 360B, and if the total measurement elapsed time has not exceeded T_{PPD}, execution may return to stages 320B and 330B for additional primary and validating estimate generation.

If time period T_{PPD} has elapsed, estimation may be stopped at stage 360B, with a non-converging enhanced distance estimate D optionally generated at stage 380B and/or the non-converging results and/or any associated data stored at stage 385B and/or distributed to other wired or wireless devices connected to the network.

In addition, in some embodiments, process stages 380B and 385B may be omitted, with execution returning to stage 310B to repeat the measurement process one or more additional cycles.

In some embodiments of process 300B the following observations may be relevant. First, if convergence frequently occurs before T_{PPD} elapses, the overall measurement time could be decreased, either statically or dynamically. This time reduction may depend on how often the PPD and RSSI validating algorithms converge and/or how early they converge. Second, repeating the measurement process upon failure of convergence at stage 360B may offer more confidence as to the correctness of the measured value, although it may not be a sufficient condition for its correctness. Therefore, in some embodiments it may be advantageous to repeat the process stages of process 300B multiple times in order to generate a more reliable estimate. Third, in spite of the fact that restarting a measurement may insert additional time, the possibility of convergence has the potential for saving some time in other measurements performed in the wireless system.

In some embodiments measurement time performance for the dual approach as implemented in process 300B may be derived as is further explained below.

Measurement Time Analysis for Some Embodiments

If we denote the average time after which the estimations from both RSSI and PPD converges to an accurate value as T̅, T̅≦T_{PPD} (i.e. the default specified required measurement time for the PPD approach). Also we can denote the probability of convergence as α, 0≦α≦1. An objective is to find the average measurement time T_{avg} with the dual approach. T_{avg} can be computed as:

T_{avg}=α T̅+(1−α)T_{N} (8)

where T_{N} represents the time required in case of non-convergence.

First: If the measurement process is stopped at some time instant in case of early convergence that lasts at least T_{w} and just continued up to T_{PPD} in case of non-convergence, then simply T_{N}=T_{PPD} and the average measurement time would be:

T_{avg}=α T̅+(1−α)T_{PPD}. (9)

Second: If the measurement process is repeated in case of non-convergence, then T_{N} is recursive and given by:

T_{N}=T_{PPD}+α T̅+(1−α)T_{N} (10)

T_{N} can be written as a series expansion by:

$${T}_{N} = {\sum }_{n = 0}^{∞} {( 1 - α )}^{n} {T}_{PPD} + {\sum }_{n = 0}^{∞} {α ( 1 - α )}^{n} \overline{T} \qquad ( 11 )$$

Substituting in (6), we have:

$${T}_{avg} = α \overline{T} + ( 1 - α ) ( {T}_{PPD} + α \overline{T} ) {\sum }_{n = 0}^{∞} {( 1 - α )}^{n} \qquad ( 12 )$$

The series in (10) is a power series that converges to 1/α. Therefore, the average measurement time in (10) can be computed as:

$${T}_{avg} = \overline{T} + \frac{( 1 - α ) {T}_{PPD}}{α} \qquad ( 13 )$$

Third: If one only assumes that accurate results should converge up to T̅, and repeat the measurements if they are non-convergent at time instance T̅, then in this case T_{N} is also recursive and given by:

T_{N}= T̅+α T̅+(1−α)T_{N} (14)

Following the approach above, it can be easily shown that the average measurement time is given by:

$${T}_{avg} = \frac{\overline{T}}{α} \qquad ( 15 )$$

Therefore, by utilizing the PPD and RSSI approaches and if the probability of convergence is high, it may not only be possible to validate the correctness of estimations but also to reduce the measurement time and consequently save some of the wireless bandwidth used by the signaling packets used in measurements.

While there have been shown what are presently considered to be preferred embodiments of the present invention, it will be apparent to those skilled in the art that various changes and modifications can be made herein without departing from the scope and spirit of the invention.

Each of the patent applications, patents, publications, and other published documents as well as appendices mentioned or referred to in this specification as well as in any parent applications is hereby incorporated by reference herein in its entirety, to the same extent as if each individual patent application, patent, publication, and other published document was specifically and individually indicated to be incorporated by reference.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, hardware, software, or firmware configuration, material or materials, algorithm, method, process stage or stages, to the objective, spirit, and scope of the invention. All such modifications are intended to be within the scope of the invention and any claims appended hereto.

It is noted that in various embodiments the present invention may relate to processes such as are described or illustrated herein and/or in the related applications. These processes are typically implemented in one or more modules, and such modules may include computer software stored on a computer readable medium including instructions configured to be executed by one or more processors. It is further noted that, while the processes described and illustrated herein and/or in the related applications may include particular stages, it is apparent that other processes including fewer, more, or different stages than those described and shown are also within the spirit and scope of the present invention. Accordingly, the processes shown herein and in the related applications are provided for purposes of illustration, not limitation.

As noted, some embodiments of the present invention may include software and/or computer hardware/software combinations configured to implement one or more processes or functions associated with the present invention in conjunction with one or more processors. These embodiments may be in the form of modules implementing functionality in software and/or hardware software combinations. Embodiments may also take the form of a computer storage product with a processor readable medium having computer code thereon for performing various computer-implemented operations, such as operations related to functionality as described herein. The media and computer code may be those specially designed and constructed for the purposes of the present invention, or they may be of the kind well known and available to those having skill in the computer software arts, or they may be a combination of both.

Examples of processor readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for estimating distance in a wireless network, comprising:
determining a first distance estimate between a first wireless device and a second wireless device using a first distance measurement method;
determining a second distance estimate between the first wireless device and the second wireless device using a second distance measurement method;
testing the first distance estimate and the second distance estimate for convergence; and
providing, responsive to the testing, a convergence result when the first distance estimate and the second distance estimate are convergent.

2. The method of claim 1 wherein the convergence result includes an enhanced distance estimate based at least in part on the first distance estimate and the second distance estimate.

3. The method of claim 2 wherein the enhanced distance estimate is an average of the first distance estimate and the second distance estimate.

4. The method of claim 2 wherein the enhanced distance estimate is a weighted average of the first distance estimate and the second distance estimate.

5. The method of claim 1 wherein one of the first and second distance measurement methods is a transmission time distance measurement method.

6. The method of claim 5 wherein the transmission time distance measurement method is a packet propagation delay (PPD) method.

7. The method of claim 1 wherein one of the first and second distance measurement methods is a signal strength distance measurement method.

8. The method of claim 7 wherein the signal strength distance measurement method is a received signal strength indication (RSSI) distance measurement method.

9. The method of claim 1 wherein the first distance measurement method is a PPD distance measurement method and the second distance measurement method is an RSSI distance measurement method.

10. The method of claim 1 wherein the first distance measurement method and the second distance measurement method are selected so that the first distance estimate and the second distance estimate will be statistically independent.

11. The method of claim 1 wherein the first distance measurement method and the second distance measurement method are simultaneously executed.

12. The method of claim 1 wherein said testing comprises:
generating an error function based on the first and second distance estimates;
comparing the error function to a predefined error threshold; and
determining that the first and second distance estimates are convergent if the error function is within the predefined error threshold.

13. The method of claim 12 wherein the error function is based on a predetermined percentage difference between the first and second distance estimates.

14. The method of claim 12 wherein the error function is based on a predetermined distance difference between the first and second distance estimates.

15. The method of claim 1 further comprising:
determining, if the first and second distance estimates are not convergent, whether a predefined measurement duration has been exceeded; and
performing a second distance measurement estimate if the predefined measurement duration has not been exceeded, the second distance measurement estimate comprising:
determining a third distance estimate between the first wireless device and the second wireless device based on the first distance measurement method;
determining a fourth distance estimate between the first wireless device and the second wireless device based on the second distance measurement method;
testing the third distance estimate and the fourth distance estimate for convergence; and
providing, responsive to the testing, a convergence result when the third distance estimate and the fourth distance estimate are convergent.

16. The method of claim 1 wherein the wireless network is an IEEE 802.11 wireless network.

17. The method of claim 1 wherein the wireless network is an IEEE 802.16 wireless network.

18. A method for estimating distance in a wireless network, comprising:
determining a plurality of distance estimates between a first wireless device and a second wireless device, wherein each of said plurality of distance estimates is based on a different distance estimation method;
testing the plurality of distance estimates for convergence; and
providing, responsive to the testing, a convergence result when the plurality of distance estimates are convergent.

19. The method of claim 18 wherein said testing comprises:
generating an error function based on two or more of the plurality of distance estimates;
comparing the error function to a predefined error threshold; and
determining that the plurality of distance estimates are convergent if the error function is within the predefined error threshold.

20. The method of claim 18 wherein said testing comprises:
determining whether two or more of the plurality of distance estimates are converging within a predefined error threshold; and
responsive to said determining, identifying that the plurality of distance estimates are convergent if two or more of the plurality of distance estimates are converging.

21. The method of claim 18 wherein the convergence result comprises an enhanced distance estimate.

22. The method of claim 21 wherein the enhanced distance estimate is based on two or more of the plurality of distance estimates.

23. The method of claim 22 wherein the enhanced distance estimate is an average of two or more of the plurality of distance estimates.

24. A computer readable medium containing instructions capable of being executed by a processor to perform a distance estimation method comprising:
determining a first distance estimate between a first wireless device and a second wireless device using a first distance measurement method;
determining a second distance estimate between the first wireless device and the second wireless device using a second distance measurement method;
testing the first distance estimate and the second distance estimate for convergence; and
providing, responsive to the testing, a convergence result when the first distance estimate and the second distance estimate are convergent.

25. The computer readable medium of claim 24 wherein the convergence result includes an enhanced distance estimate based at least in part on the first distance estimate and the second distance estimate.

26. The computer readable medium of claim 25 wherein the enhanced distance estimate is an average of the first distance estimate and the second distance estimate.

27. The computer readable medium of claim 26 wherein the enhanced distance estimate is a weighted average of the first distance estimate and the second distance estimate.

28. The computer readable medium of claim 24 wherein one of the first and second distance measurement methods is a transmission time distance measurement method.

29. The computer readable medium of claim 28 wherein the transmission time distance measurement method is a packet propagation delay (PPD) method.

30. The computer readable medium of claim 24 wherein one of the first and second distance measurement methods is a signal strength distance measurement method.

31. The computer readable medium of claim 30 wherein the signal strength distance measurement method is a received signal strength indication (RSSI) distance measurement method.

32. The computer readable medium of claim 24 wherein the first distance measurement method is a PPD distance measurement method and the second distance measurement method is an RSSI distance measurement method.

33. The computer readable medium of claim 24 wherein the first distance measurement method and the second distance measurement method are selected so that the first distance estimate and the second distance estimate will be statistically independent.

34. The computer readable medium of claim 24 wherein the first distance measurement method and the second distance measurement method are simultaneously executed.

35. The computer readable medium of claim 24 wherein said testing comprises:
generating an error function based on the first and second distance estimates;
comparing the error function to a predefined error threshold; and
determining that the first and second distance estimates are convergent if the error function is within the predefined error threshold.

36. The computer readable medium of claim 35 wherein the error function is based on a predetermined percentage difference between the first and second distance estimates.

37. The computer readable medium of claim 35 wherein the error function is based on a predetermined distance difference between the first and second distance estimates.

38. The computer readable medium of claim 24 further comprising:
determining, if the first and second distance estimates are not convergent, whether a predefined measurement duration has been exceeded; and
performing a second distance measurement estimate if the predefined measurement duration has not been exceeded, the second distance measurement estimate comprising:
determining a third distance estimate between the first wireless device and the second wireless device based on the first distance measurement method;
determining a fourth distance estimate between the first wireless device and the second wireless device based on the second distance measurement method;
testing the third distance estimate and the fourth distance estimate for convergence; and
providing, responsive to the testing, a convergence result when the third distance estimate and the fourth distance estimate are convergent.

39. The computer readable medium of claim 24 wherein the wireless network is an IEEE 802.11 wireless network.

40. The computer readable medium of claim 24 wherein the wireless network is an IEEE 802.16 wireless network.

41. A computer readable medium containing instructions capable of being executed by a processor to perform a distance estimation method comprising:
determining a plurality of distance estimates between a first wireless device and a second wireless device, wherein each of said plurality of distance estimates is based on a different distance estimation method;
testing the plurality of distance estimates for convergence; and
providing, responsive to the testing, a convergence result when the plurality of distance estimates are convergent.

42. The computer readable medium of claim 41 wherein said testing comprises:
generating an error function based on two or more of the plurality of distance estimates;
comparing the error function to a predefined error threshold; and
determining that the plurality of distance estimates are convergent if the error function is within the predefined error threshold.

43. The computer readable medium of claim 41 wherein said testing comprises:
determining whether two or more of the plurality of distance estimates are converging within a predefined error threshold; and
responsive to said determining, identifying that the plurality of distance estimates are convergent if two or more of the plurality of distance estimates are converging.

44. The computer readable medium of claim 41 wherein the convergence result comprises an enhanced distance estimate.

45. The computer readable medium of claim 44 wherein the enhanced distance estimate is based on two or more of the plurality of distance estimates.

46. The computer readable medium of claim 45 wherein the enhanced distance estimate is an average of two or more of the plurality of distance estimates.

47. A wireless device comprising:
a processor;
a memory; and
a computer readable medium containing instructions capable of being executed by the processor to perform a distance estimation method comprising:
determining a first distance estimate between a first wireless device and a second wireless device using a first distance measurement method;
determining a second distance estimate between the first wireless device and the second wireless device using a second distance measurement method;
testing the first distance estimate and the second distance estimate for convergence;
providing, responsive to the testing, a convergence result when the first distance estimate and the second distance estimate are convergent; and
storing the convergence result in the memory.

48. The wireless device of claim 47 wherein the convergence result includes an enhanced distance estimate based at least in part on the first distance estimate and the second distance estimate.

49. The wireless device of claim 48 wherein the enhanced distance estimate is an average of the first distance estimate and the second distance estimate.

50. The wireless device of claim 47 wherein the first distance measurement method is a PPD distance measurement method and the second distance measurement method is an RSSI distance measurement method.
